(19) United States
(12) Patent Application Publication
(10) Pub. No.: US 2025/0101160 A1
(43) Pub. Date: Mar. 27, 2025

(54) CYCLIC OLEFIN COPOLYMER, AND METHOD FOR PRODUCING CYCLIC OLEFIN COPOLYMER

(71) Applicant: POLYPLASTICS CO., LTD., Tokyo (JP)

(72) Inventors: Yu MIYAGI, Fuji-shi (JP); Itsuki SAITO, Fuji-shi (JP)

(21) Appl. No.: 18/730,102

(22) PCT Filed: Feb. 2, 2023
(86) PCT No.: PCT/JP2023/003404

§ 371 Date: Jul. 18, 2024

(30) Foreign Application Priority Data
Feb. 2, 2022 (JP) 2022-015136

(51) Int. Cl. C08F 232/04; C08F 4/659; C08F 4/6592; C08F 210/14

(52) U.S. Cl. CPC C08F 232/04; C08F 4/65908; C08F 4/6592; C08F 210/14; C08F 2420/02

(57) ABSTRACT

A cyclic olefin copolymer that is a copolymer of a cyclic olefin monomer and an α-olefin having 3 or more and 20 or less carbon atoms, which has excellent tensile strength and breaking strain, and a method for producing the cyclic olefin copolymer. In the copolymer, the amount of structural units derived from the α-olefin is 10 mol % or more and 50 mol % or less relative to the entire structural units, and in a one-dimensional scattering curve with respect to the scattering vector q of small angle X-ray scattering for the cyclic olefin copolymer, a value obtained by dividing the half value width of a primary peak by the q value of the peak top thereof is in the range of 0.15 to 0.45.

### TECHNICAL FIELD

The present invention relates to a cyclic olefin copolymer and a method for producing the cyclic olefin copolymer.

### BACKGROUND ART

Cyclic olefin polymers and cyclic olefin copolymers (also referred to as, for example, “COPs” and “COCs”, respectively) have low moisture absorption and high transparency. For this reason, COPs and COCs are used in a variety of applications, including the fields of optical materials such as optical disc substrates, optical films, and optical fibers. Representative COCs include copolymers of a cyclic olefin and ethylene. The glass transition temperature (Tg) of such copolymers can be changed depending on the copolymerization composition of the cyclic olefin and ethylene. Therefore, copolymers of a cyclic olefin and ethylene can be produced as copolymers having a Tg higher than that of COPs, and it is also possible to achieve a Ty of higher than 200° C., which is difficult to achieve for COPs. However, such copolymers have properties of being hard and brittle. Therefore, such copolymers have problems of low mechanical strength and poor handleability and processability.

One method to improve the mechanical strength of COCs with a high Tg is to copolymerize a cyclic olefin and an α-olefin other than ethylene (hereinafter, referred to as “specific α-olefin”). Various studies have been conducted on copolymerization of a cyclic olefin and a specific φ-olefin.

Copolymerization of a cyclic olefin and a specific α-olefin is very different from copolymerization of a cyclic olefin and ethylene. In the case where a cyclic olefin is copolymerized with a specific φ-olefin under the conditions where a high molecular weight product can be obtained by copolymerization of a cyclic olefin and ethylene, it has been difficult to obtain a copolymer with a high molecular weight. This is because, in the copolymerization of a cyclic olefin and a specific α-olefin, a chain transfer reaction caused by the specific α-olefin occurs. Therefore, copolymers of a cyclic olefin and a specific α-olefin have been considered to be not suited for molding materials (see, for example, Non Patent Literature 1).

For this reason, various investigations have been conducted to improve the moldability of copolymers of a cyclic olefin and a specific α-olefin. For example, as a method for producing a copolymer of a cyclic olefin and a specific α-olefin that has a certain degree of high molecular weight and can be molded into a film, there is proposed a method in which a cyclic olefin and a specific α-olefin are copolymerized under the coexistence of a titanocene catalyst with a specific structure and triphenylmethylium tetrakis(pentafluorophenyl) borate (see Patent Literature 1).

### Citation List

### [Patent Literature]

[Patent Literature 1] Japanese Patent Laid-Open No. 2016-56275

### [Non Patent Literature]

[Non Patent Literature 1] Jung, H. Y. et al., Polyhedron, 2005, vol. 24, p. 1269-1273

### SUMMARY OF INVENTION

### Technical Problem

However, even by the method described in Patent Literature 1, it is difficult to produce a cyclic olefin copolymer that is a copolymer of a cyclic olefin and a specific α-olefin, the copolymer having excellent breaking strain.

The present invention was made in view of the above circumstances, and an object thereof is to provide a cyclic olefin copolymer that is a copolymer of a cyclic olefin monomer and an α-olefin having 3 or more and 20 or less carbon atoms, the copolymer having excellent tensile strength and breaking strain, and a method for producing the cyclic olefin copolymer, the method capable of producing the cyclic olefin copolymer well.

### Solution to Problem

The present inventors have found that the above problem can be solved when, in the copolymer of a cyclic olefin monomer and an α-olefin having 3 or more and 20 or less carbon atoms, the amount of structural units derived from the α-olefin is 10 mol % or more and 50 mol % or less relative to the entire structural units, and the cyclic olefin copolymer has a primary peak in a one-dimensional scattering curve with respect to the scattering vector q of small angle X-ray scattering and a value obtained by dividing the half value width of the primary peak by the q value of the peak top thereof is in the range of 0.15 to 0.45, resulting in the completion of the present invention. More specifically, the present invention provides the followings.

(I) A cyclic olefin copolymer that is an addition polymer of a cyclic olefin monomer and an α-olefin having 3 or more and 20 or less carbon atoms, wherein
the ratio of the number of moles of structural units derived from the α-olefin to the number of moles of the entire structural units is 10 mol % or more and 50 molt or less, and
a one-dimensional scattering curve with respect to the scattering vector q of small angle X-ray scattering for the cyclic olefin copolymer has a primary peak, and a value obtained by dividing the half value width of the primary peak by the q value of the peak top thereof is in the range of 0.15 to 0.45,
wherein the scattering vector q=(4π sin θ)/λ, π represents the circular constant, 2θ represents the scattering angle, and λ represents the wavelength of incident X-rays.

(II) The cyclic olefin copolymer according to (I), wherein the value obtained by dividing the half value width of the primary peak by the q value of the peak top thereof is in the range of 0.20 to 0.40.

(III) A method for producing the cyclic olefin copolymer according to (I) or (II), comprising
subjecting the cyclic olefin monomer and the α-olefin to addition polymerization in the presence of a titanocene catalyst represented by the following formula (1) and a co-catalyst,
wherein the co-catalyst comprises a borate compound and a hindered phenol, and
the cyclic olefin monomer and the α-olefin are each dividedly added two or more times to a reaction system in which the addition polymerization is performed.

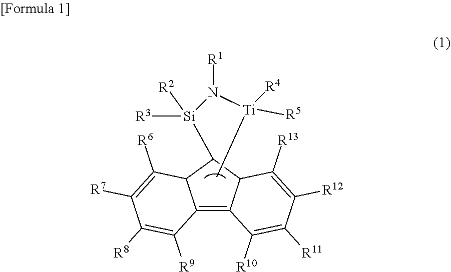

(In the formula (1), R¹ to R³ are each independently an alkyl group having 1 or more and 6 or less carbon atoms or an aryl group having 6 or more and 12 or less carbon atoms, R⁴ and R⁵ are each independently an alkyl group having 1 or more and 12 or less carbon atoms, an aryl group having 6 or more and 12 or less carbon atoms, or a halogen atom, and R⁶ to R¹³ are each independently a hydrogen atom, an alkyl group having 1 or more and 12 or less carbon atoms, an aryl group having 6 or more and 12 or less carbon atoms, or a silyl group optionally having a monovalent hydrocarbon group having 1 or more and 12 or less carbon atoms as a substituent.)

(IV) A method for producing the cyclic olefin copolymer according to (I) or (II), comprising
subjecting the cyclic olefin monomer and the α-olefin to addition polymerization in the presence of a titanocene catalyst represented by the following formula (1) and a co-catalyst,
wherein the co-catalyst comprises a borate compound and a hindered phenol, and
the addition polymerization is performed at a temperature in the range of 10° C. or higher and 60° C. or lower.

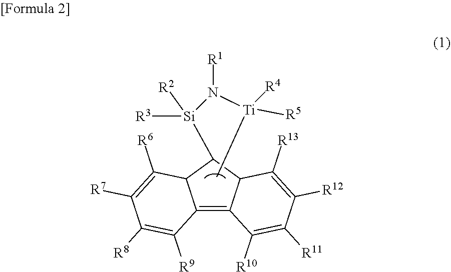

(In the formula (1), R¹ to R³ are each independently an alkyl group having 1 or more and 6 or less carbon atoms or an aryl group having 6 or more and 12 or less carbon atoms, R⁴ and R⁵ are each independently an alkyl group having 1 or more and 12 or less carbon atoms, an aryl group having 6 or more and 12 or less carbon atoms, or a halogen atom, and R⁶ to R¹³ are each independently a hydrogen atom, an alkyl group having 1 or more and 12 or less carbon atoms, an aryl group having 6 or more and 12 or less carbon atoms, or a silyl group optionally having a monovalent hydrocarbon group having 1 or more and 12 or less carbon atoms as a substituent.)

### Advantageous Effects of Invention

According to the present invention, there can be provided a cyclic olefin copolymer that is a copolymer of a cyclic olefin monomer and an α-olefin having 3 or more and 20 or less carbon atoms, the copolymer having excellent tensile strength and breaking strain, and a method for producing the cyclic olefin copolymer, the method capable of producing the cyclic olefin copolymer well.

### DESCRIPTION OF EMBODIMENTS

Hereinafter, embodiments of the present invention will be described in detail. Note that the present invention is not limited to the following embodiments.

### <<Cyclic Olefin Copolymer>>

The cyclic olefin copolymer is an addition polymer of a cyclic olefin monomer and an α-olefin having 3 or more and 20 or less carbon atoms. In the cyclic olefin copolymer, the ratio of the number of moles of structural units derived from the α-olefin to the number of moles of the entire structural units is 10 molt or more and 50 mol % or less. Also, a one-dimensional scattering curve with respect to the scattering vector q of small angle X-ray scattering for the cyclic olefin copolymer has a primary peak, and a value obtained by dividing the half value width of the primary peak by the q value of the peak top thereof is in the range of 0.15 to 0.45.

The value obtained by dividing the half value width of the primary peak by the q value of the peak top thereof is preferably in the range of 0.20 to 0.40.

By calculating the half value width (hereinafter, referred to as FWHM) of an approximate curve assuming a Gaussian distribution and the q value of the peak top (hereinafter, referred to as q*) for the primary peak of the one-dimensional scattering curve with respect to the scattering vector q obtained by small angle X-ray scattering measurement, the FWHM/q*, which is the numerical value obtained by dividing the FWHM by q*, can be calculated,

Here, the scattering vector q=(4π sin θ)/λ, π represents the circular constant, 2θ represents the scattering angle, and λ represents the wavelength of incident X-rays.

It is known that the mechanical strength of copolymers is affected by the presence or absence of phase separation of each component copolymerized, the size of the phase structure, and an abundance ratio thereof. For example, in the case where phase separation does not occur, a single mechanical strength is exhibited, but in the case where phase separation does occur, the mechanical strength of each component present is reflected, and the degree of influence of each component is considered to vary depending on the size and abundance ratio of each component. From the above, it can be said that controlling the phase separation behavior of copolymers is necessary to obtain materials with excellent tensile strength and breaking strain. The phase separation behavior of cyclic olefin copolymers can be evaluated by a one-dimensional scattering curve with respect to the scattering vector q obtained by small angle X-ray scattering measurement.

The presence of a primary peak in the one-dimensional scattering curve with respect to the scattering vector q of small angle X-ray scattering indicates that phase separation has occurred in cyclic olefin copolymers. Also, the value obtained by dividing the half value width of the primary peak by the q value of the peak top thereof indicates how highly ordered the phase separation is.

The above cyclic olefin copolymer has excellent tensile strength and breaking strain.

Specifically, the cyclic olefin copolymer preferably exhibits a tensile strength of 25 MPa or more, more preferably 30 MPa or more, and still more preferably 40 MPa or more, as the measured value by a tensile test carried out using a No. 2 dumb-bell test specimen with a thickness of 50 μm at 23° C. by the method in accordance with ISO 527-3.

Also, the cyclic olefin copolymer preferably exhibits a breaking strain of 3.5% or more, more preferably 5% or more, as the measured value by a tensile test by the above method.

Furthermore, the cyclic olefin copolymer preferably exhibits a tensile modulus of 1000 MPa or more, more preferably 1100 MPa or more, and still more preferably 1500 MPa or more, as the measured value by a tensile test by the above method.

In the cyclic olefin copolymer, the ratio of the number of moles of structural units derived from the α-olefin to the number of moles of the entire structural units is 10 molt or more and 50 mol % or less, preferably 15 mol % or more and 45 mol % or less, more preferably 20 mol % or more and 40 mol % or less, still more preferably 20 mol % or more and 35 mol % or less, and particularly preferably 20 mol % or more and 30 molt or less. When the ratio of the number of moles of structural units derived from the α-olefin is too high, it is difficult to obtain a cyclic olefin copolymer with high tensile strength and tensile modulus. When the ratio of the number of moles of structural units derived from the α-olefin is too high, it is difficult to obtain a cyclic olefin copolymer that has high glass transition temperature and excellent heat resistance,

The ratio of the number of moles of structural units derived from the α-olefin can be calculated by measuring the 13C-NMR spectrum.

The cyclic olefin copolymer may contain further structural units other than structural units derived from the cyclic olefin monomer and structural units derived from the α-olefin having 3 or more and 20 or less carbon atoms, to the extent that the object of the present invention is not hindered. As the further structural units, structural units can be employed that are copolymerizable with the cyclic olefin monomer and the α-olefin having 3 or more and 20 or less carbon atoms and are derived from a compound having a carbon-carbon unsaturated double bond. Typically, structural units derived from ethylene are preferred as the further structural units.

In the cyclic olefin copolymer, the total of the ratio of the number of moles of structural units derived from the cyclic olefin monomer and the ratio of the number of moles of structural units derived from the α-olefin to the number of moles of the entire structural units is preferably 80 mol % or more, more preferably 90 mol % or more, still more preferably 95 mol& or more, and most preferably 100 molt.

The cyclic olefin copolymer preferably has two or more glass transition temperatures in the range of 0° C. to 300° C. as measured by viscoelasticity.

The glass transition temperature can be measured by performing viscoelastic behavior observation at-100° C. to 300° C. with a solid-state rheometer using a film-like molded product with a thickness of 50 μm. Specifically, for the peak in the tan δ chart obtained from the aforementioned measurement, the temperature at the peak top is taken as the glass transition temperature.

Since the mechanical characteristics as measured by the above tensile test are good, the cyclic olefin copolymer preferably has at least one glass transition temperature in each of the ranges of 0° C. to 100° C. and 160° C. to 300° C.

In particular, since the breaking strain as measured by the above tensile test is large, the cyclic olefin copolymer preferably has at least one glass transition temperature in each of the ranges of lower than 0° C., 0° C. to 100° C., and 160° C. to 300° C.

In the above range of 0° C. to 100° C., the range of 30° C. to 80° C. is preferred, and the range of 40° C. to 70° C. is more preferred,

In the above range of 160° C. to 300° C., 170° C. to 280° C. is preferred, and 180° C. to 270° C. is more preferred.

In the above range of lower than 0° C., −50° C. to 0° C. is preferred, and −40° C. to −10° C. is more preferred.

Typically, the cyclic olefin copolymer preferably has one glass transition temperature in each of the ranges of 0° C. to 100° C. and 160° C. to 300° C., or one glass transition temperature in each of the ranges of lower than 0° C., 0° C. to 100° C., and 160° C. to 300° C.

The molecular weight of the cyclic olefin copolymer is not particularly limited. The weight average molecular weight (Mw) of the cyclic olefin copolymer is preferably 5,000 or more and 200,000 or less, more preferably 10,000 or more and 100,000 or less, as the value in terms of polystyrene, as measured by gel permeation chromatography (GPC).

The number average molecular weight (Mn) of the cyclic olefin copolymer is preferably 5,000 or more and 200,000 or less, more preferably 10,000 or more and 100,000 or less, as the value in terms of polystyrene, as measured by gel permeation chromatography (GPC).

The distribution ratio (Mw/Mn) is preferably 1.2 or more, more preferably 1.3 or more,

### <Cyclic Olefin Monomer>

The cyclic olefin monomer is not particularly limited to the extent that the object of the present invention is not hindered. Typically, norbornene and substituted norbornenes are preferably used as the cyclic olefin monomer. As the cyclic olefin monomer, norbornene is particularly preferred because of its good balance of cost, polymerizability, and physical properties of the resulting cyclic olefin copolymer. One type of cyclic olefin monomer can be used alone, or two or more types thereof can be used in combination.

The substituted norbornene is not particularly limited. Examples of substituents that the substituted norbornene has include halogen atoms and monovalent or divalent hydrocarbon groups. Specific examples of the substituted norbornene include a compound represented by the following formula (I).

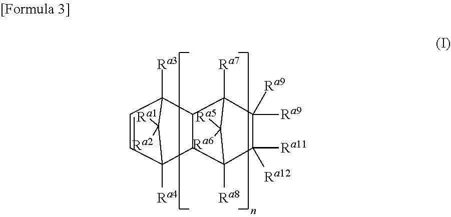

In the formula (I), R^{a1} to R^{a12} may be the same as or different from each other, and are atoms or groups selected from the group consisting of a hydrogen atom, a halogen atom, and a hydrocarbon group.

R^{a9} and R^{a10}, and R^{a11} and R^{a12} may be taken together to form a divalent hydrocarbon group.

R^{a9} or R^{a10} and R^{a11} or R^{a12} may be bonded to each other to form a ring.

n is 0 or a positive integer.

In the case where n is 2 or more, R^{a5} to R^{a8} may be the same as or different from each other in the respective repeating units.

However, in the case where n is 0, at least one of R^{a1} to R^{a4} and R^{a9} to R^{a12} is not a hydrogen atom.

Specific examples of R^{a1} to R^{a8} include a hydrogen atom; a halogen atom such as fluorine, chlorine, and bromine; and an alkyl group having 1 or more and 20 or less carbon atoms. R^{a1} to R^{a8} may all be composed of different atoms or groups. Some or all of R^{a1} to R^{a8} may be the same atom or group.

Specific examples of R^{a9} to R^{a12} include a hydrogen atom; a halogen atom such as fluorine, chlorine, and bromine; an alkyl group having 1 or more and 20 or less carbon atoms; a cycloalkyl group such as a cyclohexyl group; a substituted or unsubstituted aromatic hydrocarbon group such as a phenyl group, a tolyl group, an ethylphenyl group, an isopropylphenyl group, a naphthyl group, and an anthryl group; and an aralkyl group such as a benzyl group and a phenethyl group. Rag to R^{a12} may all be composed of different atoms or groups. Some or all of R^{a11} to R^{a12} may be the same atom or group.

Specific examples of the divalent hydrocarbon group that can be formed by Ray and R^{a10}, or R^{a11} and R^{a12} taken together include an alkylidene group such as an ethylidene group, a propylidene group, and an isopropylidene group.

In the case where R^{a9} or R^{a10} and R^{a11} or R^{a12} are bonded to each other to form a ring, the ring to be formed may be either a monocyclic or a polycyclic ring. The ring to be formed may be a polycyclic ring with crosslinking. The ring to be formed may have a double bond. The ring to be formed may have a substituent such as a methyl group.

Specific examples of the substituted norbornene represented by the formula (I) include:
a cyclic olefin with two rings such as 5-methyl-bicyclo[2.2.1]hept-2-ene, 5,5-dimethyl-bicyclo[2.2.1]hept-2-ene, 5-ethyl-bicyclo[2.2.1]hept-2-ene, 5-butyl-bicyclo[2.2.1]hept-2-ene, 5-ethylidene-bicyclo[2.2.1]hept-2-ene, 5-hexyl-bicyclo[2.2.1]hept-2-ene, 5-octyl-bicyclo[2.2.1]hept-2-ene, 5-octadecyl-bicyclo[2.2.1] hept-2-ene, 5-methylidene-bicyclo[2.2.1]hept-2-ene, 5-vinyl-bicyclo[2.2.1]hept-2-ene, and 5-propenyl-bicyclo[2.2.1]hept-2-ene;
a cyclic olefin with three rings such as tricyclo[4.3.0.1^{2,5}]deca-3,7-diene (trivial name: dicyclopentadiene), tricyclo[4.3.0.1^{2,5}] dec-3-ene; tricyclo[4.4.0.1^{2,5}]undeca-3,7-diene or tricyclo[4.4.0.1^{2,5}]undeca-3,8-diene, or tricyclo[4.4.0.1^{2,5}]undec-3-ene, which is a partially hydrogenated product thereof (or an adduct of cyclopentadiene and cyclohexene); and 5-cyclopentyl-bicyclo[2.2.1]hept-2-ene, 5-cyclohexyl-bicyclo[2.2.1]hept-2-ene, 5-cyclohexenylbicyclo[2.2.1]hept-2-ene, 5-phenyl-bicyclo[2.2.1]hept-2-ene;
a cyclic olefin with four rings such as tetracyclo[4.4.0.1^{2,5}.1^{7,10}]dodec-3-ene (also simply referred to as tetracyclododecene), 8-methyltetracyclo[4.4.0.1^{2,5}.1^{7,10}]dodec-3-ene, 8-ethyltetracyclo[4.4.0.1^{2,5}.1^{7,10}]dodec-3-ene, 8-methylidentetracyclo[4.4.0.1^{2,5}.1^{7,10}]dodec-3-ene, 8-ethylidentetracyclo[4.4.0.1^{2,5}.1^{7,10}]dodec-3-ene, 8-vinyltetracyclo[4,4.0.1^{2,5}.1^{7,10}]dodec-3-ene, and 8-propenyl-tetracyclo[4.4.0.1^{2,5}.1^{7,10}]dodec-3-ene; and a cyclic olefin with multiple rings such as 8-cyclopentyl-tetracyclo[4.4.0.1^{2,5}.1^{7,10}]dodec-3-ene, 8-cyclohexyl-tetracyclo[4.4.0.1^{2,5}.1^{7,10}]dodec-3-ene, 8-cyclohexenyl-tetracyclo[4.4.0.1^{2,5}.1^{7,10}]dodec-3-ene, 8-phenyl-cyclopentyl-tetracyclo[4.4.0.1^{2,5}.1^{7,10}]dodec-3-ene; tetracyclo[7.4.1^{3,6}.0^{1,9}.0^{2,7}]tetradeca-4,9,11,13-tetraene (also referred to as 1,4-methano-1,4,4a,9a-tetrahydrofluorene), tetracyclo[8.4.1^{4,7}.0^{1,10}.0^{3,8}]pentadeca-5,10,12,14-tetraene (also referred to as 1,4-methano-1,4,4a,5,10,10a-hexahydroanthracene); pentacyclo[6.6.1.1^{3,6}.0^{2,7}.0^{9,14}]-4-hexadecene, pentacyclo[6.5.1.1^{3,6}.0^{2,7}.0^{9,13}]-4-pentadecene, pentacyclo[7.4.0.0^{2,7}.1^{3,6}.1^{10,13}]-4-pentadecene; heptacyclo[8.7.0.1^{2,9}.1^{4,7}.1^{11,17}.0^{3,8}.0^{12,16}]-5-eicosene, heptacyclo[8.7.0.1^{2,9}.0^{3,8}.1^{4,7}.0^{12,17}.1^{13,16}]-14-eicosene; and tetramer of cyclopentadiene,

Among these, for example, an alkyl-substituted norbornene such as bicyclo[2.2.1]hept-2-ene substituted with one or more alkyl groups and an alkylidene-substituted norbornene such as bicyclo[2.2.1]hept-2-ene substituted with one or more alkylidene groups are preferred. 5-Ethylidene-bicyclo[2.2.1]hept-2-ene (trivial name: 5-ethylidene-2-norbornene, or simply ethylidenenorbornene) is particularly preferred.

### <α-Olefin>

The α-olefin is an α-olefin having 3 or more and 20 or less carbon atoms.

As such an α-olefin, not only unsubstituted α-olefins but also substituted α-olefins having a substituent such as a halogen atom can be used. The number of carbon atoms in the α-olefin is 3 or more and 20 or less, preferably 4 or more and 12 or less, and more preferably 6 or more and 10 or less.

Specific examples of the α-olefin having 3 or more and 12 or less carbon atoms include propylene, 1-butene, 1-pentene, 1-hexene, 3-methyl-1-butene, 3-methyl-1-pentene, 3-ethyl-1-pentene, 4-methyl-1-pentene, 4-methyl-1-hexene, 4,4-dimethyl-1-hexene, 4,4-dimethyl-1-pentene, 4-ethyl-1-hexene, 3-ethyl-1-hexene, 1-octene, 1-decene, and 1-dodecene. Among these, 1-hexene, 1-octene, and 1-decene are preferred.

The above cyclic olefin copolymer can be widely used in various applications such as packaging application and optical application after being mixed with various additives as necessary and then molded into a film, sheet, or the like, for example. Examples of the additive that can be added to the cyclic olefin copolymer include an antioxidant, a weather resistant stabilizer, an ultraviolet absorber, an antibacterial agent, a flame retardant, and a coloring agent. These additives are added to the cyclic olefin copolymer in amounts that take into account the general amount used depending on the type of additive.

### <<Method for Producing Cyclic Olefin Copolymer>>

Hereinafter, a method for producing the aforementioned cyclic olefin copolymer will be described.

The method for producing the cyclic olefin copolymer comprises subjecting the cyclic olefin monomer and the α-olefin to addition polymerization in the presence of a titanocene catalyst represented by the following formula (1) and a co-catalyst. The co-catalyst comprises a borate compound and a hindered phenol.

In the above production method, the cyclic olefin monomer and the α-olefin are each dividedly added two or more times to a reaction system in which the addition polymerization is performed.

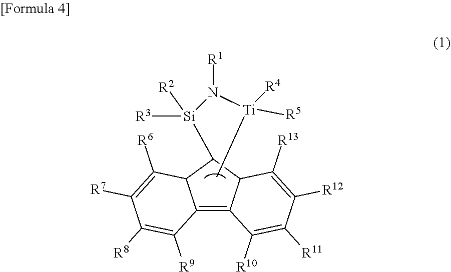

(In the formula (1), R¹ to R³ are each independently an alkyl group having 1 or more and 6 or less carbon atoms or an aryl group having 6 or more and 12 or less carbon atoms; R⁴ and R⁵ are each independently an alkyl group having 1 or more and 12 or less carbon atoms, an aryl group having 6 or more and 12 or less carbon atoms, or a halogen atom; and R⁶ to R¹³ are each independently a hydrogen atom, an alkyl group having 1 or more and 12 or less carbon atoms, an aryl group having 6 or more and 12 or less carbon atoms, or a silyl group optionally having a monovalent hydrocarbon group having 1 or more and 12 or less carbon atoms as a substituent.)

According to this method, there can be provided a cyclic olefin copolymer that satisfies the constitutional requirement described in any of the aforementioned (I) to (III). This method will also be referred to as “first production method” below.

The following production method is also preferred as the method for producing the cyclic olefin copolymer. According to this method, there can be provided a cyclic olefin copolymer that satisfies the constitutional requirement described in the aforementioned (I) or (II). Specifically, this method comprises subjecting the cyclic olefin monomer and the α-olefin to addition polymerization in the presence of a titanocene catalyst represented by the formula (1) and a co-catalyst. The co-catalyst comprises a borate compound and a hindered phenol. The addition polymerization is performed at a temperature in the range of 10° C. or higher and 60° C. or lower. The titanocene catalyst represented by the formula (1) is the same as the aforementioned titanocene catalyst for the first production method.

This method will also be referred to as “second production method” below.

### <First Production Method>

In the first production method, monomers containing the aforementioned cyclic olefin monomer and α-olefin are used. The type of cyclic olefin monomer, the type of α-olefin, and the copolymerization ratio between them are as described for the cyclic olefin copolymer.

In the first production method, the cyclic olefin monomer and the α-olefin are each dividedly added two or more times to a reaction system in which the addition polymerization is performed.

By adding the cyclic olefin monomer and the α-olefin in this manner, it is easy to obtain a cyclic olefin copolymer with good mechanical characteristics. Also, by adding the cyclic olefin monomer and the α-olefin in this manner, it is easy to obtain a cyclic olefin copolymer having a primary peak in a one-dimensional scattering curve with respect to the scattering vector q of small angle X-ray scattering in which a value obtained by dividing the half value width of the primary peak by the q value of the peak top thereof is in the range of 0.15 to 0.45.

In the case where divided addition is performed, the number of times of division is not particularly limited. The number of times of division is, for example, preferably 2 or more and 5 or less, more preferably 2 or 3, and still more preferably 2.

In the case where divided addition is performed, the amount of the cyclic olefin monomer or α-olefin added per division is preferably TA/N×0.5 or more and TA/N×1.5 or less, more preferably TA/N % 0.7 or more and TA/N×1.3 or less, and still more preferably TA/N×0.9 or more and TA/N×1.1 or less, where the mass of the entire amount added is TA and the number of times of division is N.

In the case where the number of times of division is 2, the amount of the cyclic olefin monomer or α-olefin added per division is preferably 25% by mass or more and 75% by mass or less, more preferably 35% by mass or more and 65% by mass or less, and still more preferably 45% by mass or more and 55% by mass or less, relative to the mass of the entire amount added,

In the case where divided addition is performed, at least one of the cyclic olefin monomer and the α-olefin is added to the reaction vessel at or before the initiation of addition polymerization. Then, at any timing after the initiation of addition polymerization, a second or subsequent addition of the cyclic olefin monomer or α-olefin is performed.

In the case where divided addition is performed, the time between each addition is preferably 3 minutes or longer and 20 minutes or shorter, more preferably 5 minutes or longer and 15 minutes or shorter.

In the case where divided addition is performed, the timing of the addition of cyclic olefin monomer and the timing of the addition of α-olefin may be the same or different.

Also, the number of times of division of the addition of cyclic olefin monomer and the number of times of division of the addition of α-olefin may be different.

As mentioned above, when producing the cyclic olefin copolymer, the titanocene catalyst represented by the above formula (1) is used.

In the formula (1), R¹ to R³ are each independently an alkyl group having 1 or more and 6 or less carbon atoms or an aryl group having 6 or more and 12 or less carbon atoms. Specific examples thereof may include an alkyl group such as a methyl group, an ethyl group, a propyl group, an isopropyl group, a butyl group, an isobutyl group, a t-butyl group, a pentyl group, a hexyl group, a cyclopentyl group, and a cyclohexyl group; and an aryl group such as a phenyl group, a biphenyl group, a phenyl group or biphenyl group having the above alkyl group as a substituent, a naphthyl group, and a naphthyl group having the above alkyl group as a substituent.

R⁴ and R⁵ are each independently an alkyl group having 1 or more and 12 or less carbon atoms, an aryl group having 6 or more and 12 or less carbon atoms, or a halogen atom, and specific examples thereof may include a halogen atom such as a fluorine atom, a chlorine atom, a bromine atom, and an iodine atom; a methyl group, an ethyl group, a propyl group, an isopropyl group, a butyl group, an isobutyl group, a t-butyl group, a pentyl group, a hexyl group, a heptyl group, an octyl group, a cyclopentyl group, a cyclohexyl group, and these alkyl groups having the above halogen atom as a substituent; and a phenyl group, a biphenyl group, a naphthyl group, and these aryl groups having the above halogen atom or alkyl group as a substituent.

R⁶ to R¹³ are each independently a hydrogen atom, an alkyl group having 1 or more and 12 or less carbon atoms, an aryl group having 6 or more and 12 or less carbon atoms, or a silyl group optionally having a monovalent hydrocarbon group having 1 or more and 12 or less carbon atoms as a substituent. Specific examples of the alkyl group having 1 or more and 12 or less carbon atoms may include a methyl group, an ethyl group, a propyl group, an isopropyl group, a butyl group, an isobutyl group, a t-butyl group, a pentyl group, a hexyl group, a heptyl group, an octyl group, a cyclopentyl group, and a cyclohexyl group. Also, specific examples of the aryl group having 6 or more and 12 or less carbon atoms may include a phenyl group, a biphenyl group, a naphthyl group, and these aryl groups having the above alkyl group as a substituent. Furthermore, specific examples of the silyl group having a monovalent hydrocarbon group having 1 or more and 12 or less carbon atoms as a substituent may include a silyl group having, as a substituent, an alkyl group having 1 or more and 12 or less carbon atoms such as a methyl group, an ethyl group, a propyl group, an isopropyl group, a butyl group, an isobutyl group, a t-butyl group, a pentyl group, a hexyl group, a heptyl group, an octyl group, a cyclopentyl group, and a cyclohexyl group.

Specific examples of the titanocene catalyst represented by the general formula (1) may include (isopropylamido)dimethyl-9-fluorenylsilane titanium dimethyl, (isobutylamido)dimethyl-9-fluorenylsilane titanium dimethyl, (t-butylamido)dimethyl-9-fluorenylsilane titanium dimethyl, (isopropylamido)dimethyl-9-fluorenylsilane titanium dichloride, (isobutylamido)dimethyl-9-(3,6-dimethylfluorenyl)silane titanium dichloride, (t-butylamido)dimethyl-9-fluorenylsilane titanium dichloride, (isopropylamido)dimethyl-9-(3,6-dimethylfluorenyl)silane titanium dichloride, (isobutylamido)dimethyl-9-(3,6-dimethylfluorenyl)silane titanium dichloride, (t-butylamido)dimethyl-9-(3,6-dimethylfluorenyl)silane titanium dimethyl, (isopropylamido)dimethyl-9-[3,6-di(i-propyl)fluorenyl]silane titanium dichloride, (isobutylamido)dimethyl-9-[3,6-di(i-propyl)fluorenyl]silane titanium dichloride, (t-butylamido)dimethyl-9-[3,6-di(i-propyl)fluorenyl]silane titanium dimethyl, (isopropylamido)dimethyl-9-[3,6-di(t-butyl)fluorenyl]silane titanium dichloride, (isobutylamido)dimethyl-9-[3,6-di(t-butyl)fluorenyl]silane titanium dichloride, (t-butylamido)dimethyl-9-[3,6-di(t-butyl)fluorenyl]silane titanium dimethyl, (isopropylamido)dimethyl-9-[2,7-di(t-butyl)fluorenyl]silane titanium dichloride, (isobutylamido)dimethyl-9-[2,7-di(t-butyl)fluorenyl]silane titanium dichloride, (t-butylamido)dimethyl-9-[2,7-di(t-butyl)fluorenyl]silane titanium dimethyl, (isopropylamido)dimethyl-9-(2,3,6,7-tetramethylfluorenyl)silane titanium dichloride, (isobutylamido)dimethyl-9-(2,3,6,7-tetramethylfluorenyl)silane titanium dichloride, and (t-butylamido)dimethyl-9-(2,3,6,7-tetramethylfluorenyl)silane titanium dimethyl. It is preferably (t-butylamido)dimethyl-9-fluorenylsilane titanium dimethyl((t-BuNSiMe₂Flu)TiMe₂). (t-BuNSiMe₂Flu)TiMe₂ is a titanium complex represented by the following formula (2), and can be readily synthesized based on, for example, the description in “Macromolecules, Vol. 31, p. 3184, 1998”.

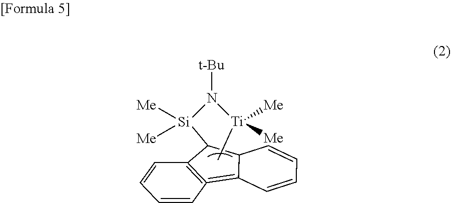

(In the formula, Me represents a methyl group, and t-Bu represents a tert-butyl group.)

The amount of the above titanocene catalyst used is not particularly limited as long as the addition polymerization reaction proceeds well. The amount of the titanocene catalyst used is preferably 0.001 parts by mass or more and 10 parts by mass or less, more preferably 0.01 parts by mass or more and 5 parts by mass or less, and still more preferably 0.1 parts by mass or more and 1 part by mass or less, relative to 100 parts by mass of the total amount of the cyclic olefin monomer and the α-olefin.

The addition polymerization of monomers containing the cyclic olefin monomer and α-olefin is performed under the coexistence of the above titanocene catalyst and a co-catalyst. The co-catalyst comprises a borate compound and a hindered phenol.

By performing addition polymerization under the coexistence of the above titanocene catalyst and co-catalyst to satisfy the aforementioned predetermined conditions, a cyclic olefin copolymer that has both excellent breaking strain and excellent toughness can be obtained.

As the borate compound, borate compounds conventionally used as a co-catalyst in homopolymerization or copolymerization of cyclic olefin monomers can be used without any particular limitation. Specific preferred examples of the borate compound include triphenylmethylium tetrakis(pentafluorophenyl) borate, dimethylphenylammonium tetrakis(pentafluorophenyl) borate, N,N-dimethylanilinium tetrakis(pentafluorophenyl) borate, and N-methyl-di-n-decylammonium tetrakis(pentafluorophenyl) borate.

As the hindered phenol, hindered phenols conventionally used as a co-catalyst in homopolymerization or copolymerization of cyclic olefin monomers can be used without any particular limitation.

Here, hindered phenols are phenols with a bulky substituent at at least one of the two adjacent positions of the phenolic hydroxy group. Examples of the bulky substituent include an alkyl group other than a methyl group, an alkenyl group, an alkynyl group, an aryl group, a heterocyclic group, an alkoxy group, an aryloxy group, a substituted amino group, an alkylthio group, and an arylthio group, Specific examples of the alkyl group other than a methyl group include an isopropyl group, an isobutyl group, a sec-butyl group, and a tert-butyl group.

Specific examples of the hindered phenol include 2,6-di-tert-butyl-4-hydroxytoluene (BHT), 2,6-di-tert-butylphenol, 2-tert-butylphenol, 2-tert-butyl-p-cresol, 3,3′,5,5′-tetra-tert-butyl-4,4′-dihydroxybiphenyl, 3,3′,5,5′-tetra-tert-butyl-2,2′-dihydroxybiphenyl, 4,4′-butylidenebis(3-methyl-6-tert-butylphenol), 2,2′-methylenebis(6-tert-butyl-4-methylphenol), 4,4′,4″-(1-methylpropanyl-3-ylidene)tris(6-tert-butyl-m-cresol), and 1,3,5-tris(3,5-di-tert-butyl-4-hydroxyphenylmethyl)-2,4,6-trimethylbenzene.

Among these, 2,6-di-tert-butyl-4-hydroxytoluene (BHT) and 2,6-di-tert-butylphenol are preferred as they have a low molecular weight and the effects desired by the use of hindered phenol can be easily obtained by using a small amount.

Also, the hindered phenol can increase the yield of the cyclic olefin copolymer by reacting with an alkylaluminum compound in the polymerization system. Therefore, it is preferable for the co-catalyst to further comprise an alkylaluminum compound.

Specific examples of the alkylaluminum compound include a trialkylaluminum such as trimethylaluminum, triethylaluminum, triisopropylaluminum, tri-n-butylaluminum, triisobutylaluminum, tri-sec-butylaluminum, and tri-n-octylaluminum; a dialkylaluminum halide such as dimethylaluminum chloride and diisobutylaluminum chloride; a dialkylaluminum hydride such as diisobutylaluminum hydride; and a dialkylaluminum alkoxide such as dimethylaluminum methoxide.

The amount of the above borate compound used is not particularly limited as long as the addition polymerization reaction proceeds well and the cyclic olefin copolymer with the desired properties can be obtained. The amount of the borate compound used is preferably 0.01 parts by mass or more and 100 parts by mass or less, more preferably 0.1 parts by mass or more and 10 parts by mass or less, and still more preferably 1 part by mass or more and 5 parts by mass or less, relative to 100 parts by mass of the total amount of the cyclic olefin monomer and the α-olefin.

The amount of the above hindered phenol used is not particularly limited as long as the addition polymerization reaction proceeds well and the cyclic olefin copolymer with the desired properties can be obtained. The amount of the hindered phenol used is preferably 0.001 parts by mass or more and 100 parts by mass or less, more preferably 0.01 parts by mass or more and 10 parts by mass or less, and still more preferably 0.1 parts by mass or more and 1 part by mass or less, relative to 100 parts by mass of the total amount of the cyclic olefin monomer and the α-olefin.

The amount of the above alkylaluminum compound used is not particularly limited as long as the addition polymerization reaction proceeds well and the cyclic olefin copolymer with the desired properties can be obtained. The amount of the alkylaluminum compound used is preferably 0.001 parts by mass or more and 10 parts by mass or less, more preferably 0.01 parts by mass or more and 5 parts by mass or less, and still more preferably 0.1 parts by mass or more and 1 part by mass or less, relative to 100 parts by mass of the total amount of the cyclic olefin monomer and the α-olefin.

The addition polymerization may be performed in the presence of a solvent. The solvent is not particularly limited as long as it does not inhibit the polymerization reaction. Examples of the preferred solvent include a hydrocarbon solvent and a halogenated hydrocarbon solvent, and a hydrocarbon solvent is preferred because of its excellent handleability, thermal stability, and chemical stability. Specific examples of the preferred solvent include a hydrocarbon solvent such as pentane, hexane, heptane, octane, isooctane, isododecane, mineral oil, cyclohexane, methylcyclohexane, decahydronaphthalene (decalin), benzene, toluene, and xylene, and a halogenated hydrocarbon solvent such as chloroform, methylene chloride, dichloromethane, dichloroethane, and chlorobenzene.

The solvent may be charged into the polymerization vessel by itself or may be charged into the polymerization vessel in the form of a monomer solution, a catalyst solution, or a co-catalyst solution.

In the case where a solvent is used, the amount of the solvent used is not particularly limited. The amount of the solvent used is preferably 100 parts by mass or more and 100000 parts by mass or less, more preferably 500 parts by mass or more and 10000 parts by mass or less, and still more preferably 1000 parts by mass or more and 5000 part by mass or less, relative to 100 parts by mass of the total amount of the cyclic olefin monomer and the α-olefin.

The temperature of the addition polymerization is not particularly limited. For example, the temperature of the addition polymerization is preferably −20° C. or higher and 200° C. or lower, more preferably −10° C. or higher and 10° C. or lower, and still more preferably −5° C. or higher and 5° C. or lower.

The time of the addition polymerization is not particularly limited. For example, the time of the addition polymerization is preferably 5 minutes or longer and 30 minutes or shorter, more preferably 8 minutes or longer and 20 minutes or shorter, and still more preferably 10 minutes or longer and 15 minutes or shorter.

The atmosphere in which the above addition polymerization reaction is performed is not particularly limited, but an inert gas atmosphere is preferred. As the inert gas, nitrogen gas or helium gas can be used.

After performing the addition polymerization and producing the cyclic olefin copolymer as described above, the cyclic olefin copolymer is collected from the reaction vessel according to a conventional method.

### <Second Production Method>

The second production method is the same as the first production method, except that the method for charging the cyclic olefin monomer and α-olefin is not particularly limited and that the addition polymerization is performed at a temperature in the range of 10° C. or higher and 60° C. or lower.

The method for charging the cyclic olefin monomer and α-olefin in the second production method may be the same as in the first production method. Because of the simplicity of the charging operation, the method for charging the cyclic olefin monomer and α-olefin in the second production method is preferably a method in which the cyclic olefin monomer and α-olefin are charged in a batch into the reaction vessel at or before the initiation of addition polymerization reaction.

### EXAMPLES

Hereinafter, Examples are given to specifically describe the present invention, but the present invention is not limited to these Examples.

### Examples 1 to 4

In Examples 1 to 4, 2-norbornene (Nb) and 1-octene (Oct) were used in the respective ratios described in Table 1, in amounts such that the total amount of 2-norbornene and 1-octene was 118, 8 mmol. To a 500-mL eggplant flask purged with a nitrogen atmosphere, a half amount of 2-norbornene and 1-octene, 0.198 mmol of tri-n-octylaluminum, and 0.396 mmol of 2,6-di-tert-butyl-4-hydroxytoluene were added. Thereafter, toluene was used to dilute the contents in the flask to a volume of 258 mL. Then, the contents in the flask were cooled to 0° C. After cooling, a solution of a titanocene catalyst in toluene with a concentration of 0.04 mmol/L was added to the reaction solution such that the amount of the titanocene catalyst was 0.22 mmol. As the titanocene catalyst, a compound represented by the aforementioned formula (2) was used. Next, a solution of a borate compound in toluene with a concentration of 0.008 mmol/L was added to the reaction solution such that the amount of the borate compound was 0.22 mmol. As the borate compound, triphenylmethylium tetrakis(pentafluorophenyl) borate was used. After adding the titanocene catalyst and the borate compound to initiate addition polymerization, the reaction was performed at 0° C. for 10 minutes while stirring the reaction solution with a magnetic stirrer. After the reaction for 10 minutes, the remaining half amount of each of 2-norbornene and 1-octene, 0.022 mmol of tri-n-octylaluminum, and 0.044 mmol of 2,6-di-tert-butyl-4-hydroxytoluene were added to the eggplant flask, Thereafter, the addition polymerization reaction was allowed to continue for 15 minutes.

After the reaction for 25 minutes in total, a small amount of 2-propanol was added to the reaction solution to terminate the addition polymerization reaction.

Hydrochloric acid was added to the reaction solution, which was stirred for 10 minutes, and the organic layer was washed with ion exchanged water. After repeatedly performing washing with ion exchanged water until the aqueous layer became neutral, the washed organic layer was collected. The collected organic layer was dropped into a large amount of acetone to precipitate the produced cyclic olefin copolymer. After the precipitated copolymer was collected by filtration, the copolymer was washed with methanol and acetone two or more times. The washed copolymer was dried under reduced pressure at 110° C. for 16 hours or longer to obtain the dried cyclic olefin copolymer.

For the cyclic olefin copolymer obtained, the ratio of the number of moles of structural units derived from the α-olefin (1-octene) (α-olefin ratio) was specified by the following method.

About 50 mg of the obtained cyclic olefin copolymer was dissolved in 0.6 mL of chloroform-d, and the 13C-NMR spectrum was measured using AVANCE III 400+CryoProbe manufactured by BRUKER under the conditions of 300 K, 90° pulse with a repetition time of 30 seconds, and 1000 integrated cycles.

From the spectrum obtained, the α-olefin ratio was calculated in accordance with the method described in Macromolecules 2010, 43, 4527-4531 and based on the following expression. The results are described in Table 1 as Oct ratio in resin.

α-olefin ratio (mol %)=[integrated value of carbon derived from α-olefin/(integrated value of carbon derived from α-olefin+integrated value of carbon derived from cyclic olefin monomer)]×100

For the cyclic olefin copolymer obtained, molecular weight measurement by gel permeation chromatography, measurement of the half value width of a primary peak and the q value of the peak top in a one-dimensional scattering curve with respect to the scattering vector q of small angle X-ray scattering (SAXS) by the aforementioned method, measurement of the glass transition temperature by the aforementioned method, and a tensile test by the aforementioned method were performed. These measurement results are described in Tables 1 and 2. Note that the tensile test was performed using a No. 2 dumb-bell test specimen cut out from the film obtained by the following method as the measurement sample, in accordance with ISO 527-3, using a tensile tester (manufactured by A&D Company, Ltd., TENSILON Universal Material Testing Instrument RTM-100) at a temperature of 23° C., a distance of 50 mm between chucks, and a tensile speed of 50 mm/min.

The measurement sample cut out from the film obtained by the following method to a size of 4 cm×1 cm×50 μm was used. The measurement was performed using a small angle X-ray scattering apparatus “large synchrotron radiation facility SPring-8 BL-19B2” (Japan Synchrotron Radiation Research Institute) with X-rays incident from the direction perpendicular to the film sample surface. The measurement conditions are as follows. The primary peak of the one-dimensional scattering curve with respect to the scattering vector q obtained by the measurement was evaluated,
Detector: PILATUS 2M manufactured by DECTRIS AG
Wavelength of incident X-rays: 0.69 Å
Distance from measurement sample to detector: 3 m
Exposure time: 420 sec

The film used as the sample in the glass transition temperature measurement, tensile test, and small angle X-ray scattering measurement was prepared by the following method.

Using Kapton (R) film with a size of 10 cm×10 cm×50 μm, a 50 μm-deep mold frame was prepared, After filling the mold frame with the cyclic olefin copolymer obtained, the cyclic olefin copolymer filled in the mold frame was vacuum pressed using a thermal vacuum pressing machine under the conditions of a pressure of 15 MPa, a temperature of 320 to 340° C., and a time of 15 minutes.

After pressing, the pressed cyclic olefin copolymer was rapidly cooled by sandwiching it between metal plates at room temperature. After cooling, the metal plates were removed to obtain a film of the cyclic olefin copolymer with a thickness of about 50 μm.

### Examples 5 to 8

Cyclic olefin copolymers were obtained in the same manner as in Example 1, except that the entire amount of norbornene and 1-octene were charged in a batch before initiating the addition polymerization reaction, the reaction temperature was changed to 25° C., and the reaction time was changed to 10 minutes. Note that the charging ratios of norbornene and 1-octene are as shown in Table 1.

For the cyclic olefin copolymers obtained, molecular weight measurement by gel permeation chromatography, measurement of the Oct ratio in resin, measurement of the half value width of a primary peak and the q value of the peak top in a one-dimensional scattering curve with respect to the scattering vector q of small angle X-ray scattering (SAXS) by the aforementioned method, measurement of the glass transition temperature by the aforementioned method, and a tensile test by the aforementioned method were performed in the same manner as in Example 1. These measurement results are described in Tables 1 and 2.

### Comparative Example 1

A cyclic olefin copolymer was obtained in the same manner as in Example 5, except that the reaction temperature was changed to 0° C. Note that the charging ratios of norbornene and 1-octene are as described in Table 1.

For the cyclic olefin copolymer obtained, molecular weight measurement by gel permeation chromatography, measurement of the Oct ratio in resin, measurement of the half value width of a primary peak and the q value of the peak top in a one-dimensional scattering curve with respect to the scattering vector q of small angle X-ray scattering (SAXS) by the aforementioned method, measurement of the glass transition temperature by the aforementioned method, and a tensile test by the aforementioned method were performed in the same manner as in Example 1. These measurement results are shown in Table 1 and Table 2.

### Comparative Example 2

A cyclic olefin copolymer was obtained in the same manner as in Example 5, except that 0.97 mmol of CC1 below and 0.68 mmol of CC2 below were used as co-catalysts, the reaction temperature was changed to 40° C., and the polymerization time was changed to 4 hours. The charging ratios of norbornene and 1-octene and the charging method are as described in Table 1.

For the obtained cyclic olefin copolymer, molecular weight measurement by gel permeation chromatography, measurement of the Oct ratio in resin, measurement of the half value width of a primary peak and the q value of the peak top in a one-dimensional scattering curve with respect to the scattering vector q of small angle X-ray scattering (SAXS) by the aforementioned method, measurement of the glass transition temperature by the aforementioned method, and a tensile test by the aforementioned method were performed in the same manner as in Example 1. The measurement results are shown in Table 1 and Table 2.
CC1:6.5 mass % (as content of Al atoms) MMAO-3A toluene solution (solution of methylisobutylaluminoxane represented by [(CH₃)_{0.7} (iso-C₄H₉)_{0.3}AlO]ₙ, manufactured by Tosoh Finechem Corporation, note that 6 mol % of trimethylaluminum is contained relative to the entire Al)
CC2:9.0 mass % (as content of Al atoms) TMAO-211 toluene solution (solution of methylaluminoxane, manufactured by Tosoh Finechem Corporation, note that 26 mol % of trimethylaluminum is contained relative to the entire Al)

### Comparative Example 3

A cyclic olefin copolymer was obtained in the same manner as in Example 5, except that 0.22 mmol of triphenylmethylium tetrakis(pentafluorophenyl) borate alone was used as a co-catalyst, the reaction temperature was changed to 25° C., and the reaction temperature was changed to 2 hours. The charging ratios of norbornene and 1-octene are as listed in Table 1.

For the resultant cyclic olefin copolymer, molecular weight measurement by gel permeation chromatography, measurement of the Oct ratio in resin, measurement of the half value width of a primary peak and the q value of the peak top in a one-dimensional scattering curve with respect to the scattering vector q of small angle X-ray scattering (SAXS) by the aforementioned method, measurement of the glass transition temperature by the aforementioned method, and a tensile test by the aforementioned method were performed in the same manner as in Example 1. These measurement results are described in Tables 1 and 2.

TABLE 1

| | | | | | Polymer- | Polymer- | Oct | | | | Glass | |
|---|---|---|---|---|---|---|---|---|---|---|---|---|
| | Monomer charging | | | | ization | ization | ratio | | | | transition | |
| | | Number | Nb | Oct | temperature | time | in resin | Molecular weight | | | temperature | SAXS |
| | Method | of times | (mol %) | (mol %) | (° C.) | (min) | (mol %) | Mw | Mn | Mw/Mn | (° C.) | FWHM/q* |
| Exam- | Divided | 2 | 80 | 20 | 0 | 10 + 15 | 17.9 | 69 × 10³ | 55 × 10³ | 1.25 | −30/ | 0.321 |
| ple 1 | | | | | | | | | | | 65/ | |
| | | | | | | | | | | | 248 | |
| Exam- | Divided | 2 | 70 | 30 | 0 | 10 + 15 | 28.6 | 108 × 10³ | 65 × 10³ | 1.66 | −20/ | 0.277 |
| ple 2 | | | | | | | | | | | 60/ | |
| | | | | | | | | | | | 215 | |
| Exam- | Divided | 2 | 60 | 40 | 0 | 10 + 15 | 37.7 | 106 × 10³ | 86 × 10³ | 1.23 | −21/ | 0.232 |
| ple 3 | | | | | | | | | | | 59/ | |
| | | | | | | | | | | | 181 | |
| Exam- | Divided | 2 | 50 | 50 | 0 | 10 + 15 | 46.8 | 83 × 10³ | 56 × 10³ | 1.48 | −26/ | 0.182 |
| ple 4 | | | | | | | | | | | 67/ | |
| | | | | | | | | | | | 124 | |
| Exam- | Batch | 1 | 80 | 20 | 25 | 10 | 19.1 | 70 × 10³ | 53 × 10³ | 1.32 | 60/ | 0.444 |
| ple 5 | | | | | | | | | | | 260 | |
| Exam- | Batch | 1 | 70 | 30 | 25 | 10 | 28.2 | 69 × 10³ | 52 × 10³ | 1.33 | 57/ | 0.358 |
| ple 6 | | | | | | | | | | | 201 | |
| Exam- | Batch | 1 | 60 | 40 | 25 | 10 | 38.5 | 73 × 10³ | 50 × 10³ | 1.46 | 44/ | 0.273 |
| ple 7 | | | | | | | | | | | 185 | |
| Exam- | Batch | 1 | 50 | 50 | 25 | 10 | 47.8 | 70 × 10³ | 52.9 × 10³ | 1.32 | −50/ | 0.191 |
| ple 8 | | | | | | | | | | | 130 | |
| Compar- | Batch | 1 | 60 | 40 | 0 | 10 | 37.4 | 80 × 10³ | 68 × 10³ | 1.18 | −20/ | 0.124 |
| ative | | | | | | | | | | | 160 | |
| Exam- | | | | | | | | | | | | |
| ple 1 | | | | | | | | | | | | |
| Compar- | Batch | 1 | 80 | 20 | 40 | 240 | 17.7 | 127 × 10³ | 73 × 10³ | 1.74 | −20/ | N.D. |
| ative | | | | | | | | | | | 264 | |
| Exam- | | | | | | | | | | | | |
| ple 2 | | | | | | | | | | | | |
| Compar- | Batch | 1 | 50 | 50 | 25 | 120 | 48.5 | 94.6 × 10³ | 57.9 × 10³ | 1.63 | −18/ | N.D. |
| ative | | | | | | | | | | | 152 | |
| Exam- | | | | | | | | | | | | |
| ple 3 | | | | | | | | | | | | |

TABLE 2

| | Monomer | | Tensile test results | | |
|---|---|---|---|---|---|
| | charging ratio | | Tensile | Breaking | Elastic |
| | Nb | Oct | strength | strain | modulus |
| | (mol %) | (mol %) | MPa | % | MPa |
| Example 1 | 80 | 20 | 50.3 | 5.7 | 1940 |
| Example 5 | 80 | 20 | 64.0 | 4.2 | 3300 |
| Comparative | 80 | 20 | 60.0 | 3.0 | 2450 |
| Example 2 | | | | | |
| Example 2 | 70 | 30 | 45.2 | 6.3 | 1730 |
| Example 6 | 70 | 30 | 50.0 | 5.4 | 2500 |
| Example 3 | 60 | 40 | 31.0 | 30.0 | 1160 |
| Example 7 | 60 | 40 | 33.0 | 6.0 | 1580 |
| Comparative | 60 | 40 | 22.0 | 3.0 | 970 |
| Example 1 | | | | | |
| Example 4 | 50 | 50 | 16.8 | 19.3 | 690 |
| Example 8 | 50 | 50 | 18.0 | 8.6 | 750 |
| Comparative | 50 | 50 | 22.8 | 6.4 | 890 |
| Example 3 | | | | | |

According to Table 1 and Table 2, it can be seen that the cyclic olefin copolymers of Examples, in which the ratio of the number of moles of structural units derived from the α-olefin is 10 mol % or more and 50 mol % or less relative to the number of moles of the entire structural units, and in a one-dimensional scattering curve with respect to the scattering vector q of small angle X-ray scattering for the cyclic olefin copolymer, the FWHM/q*, which is the value obtained by dividing the half value width of the primary peak by the q value of the peak top, is in the range of 0.15 to 0.45, maintain high tensile strength, while having superior breaking strain to the cyclic olefin copolymers of Comparative Examples, in which the charging ratios of norbornene and 1-octene are almost the same.

What is claimed is:

1. A cyclic olefin copolymer that is an addition polymer of a cyclic olefin monomer and an α-olefin having 3 or more and 20 or less carbon atoms, wherein
a ratio of the number of moles of structural units derived from the α-olefin to the number of moles of entire structural units is 10 mol % or more and 50 mol % or less, and
a one-dimensional scattering curve with respect to a scattering vector q of small angle X-ray scattering for the cyclic olefin copolymer has a primary peak, and a value obtained by dividing a half value width of the primary peak by a q value of a peak top thereof is in a range of 0.15 to 0.45,
wherein the scattering vector q=(4π sin θ)/λ, π represents the circular constant, 2θ represents the scattering angle, and λ represents the wavelength of incident X-rays.

2. The cyclic olefin copolymer according to claim 1, wherein a value obtained by dividing a half value width of the primary peak by a q value of a peak top thereof is in a range of 0.20 to 0.40.

3. A method for producing the cyclic olefin copolymer according to claim 1, comprising
subjecting the cyclic olefin monomer and the α-olefin to addition polymerization in the presence of a titanocene catalyst represented by the following formula (1) and a co-catalyst,
wherein the co-catalyst comprises a borate compound and a hindered phenol, and
the cyclic olefin monomer and the α-olefin monomer are each dividedly added two or more times to a reaction system in which the addition polymerization is performed: 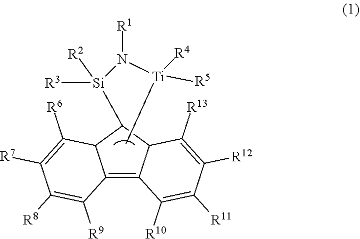
wherein R¹ to R³ are each independently an alkyl group having 1 or more and 6 or less carbon atoms or an aryl group having 6 or more and 12 or less carbon atoms, R⁴ and R⁵ are each independently an alkyl group having 1 or more and 12 or less carbon atoms, an aryl group having 6 or more and 12 or less carbon atoms, or a halogen atom, and R⁶ to R¹³ are each independently a hydrogen atom, an alkyl group having 1 or more and 12 or less carbon atoms, an aryl group having 6 or more and 12 or less carbon atoms, or a silyl group optionally having a monovalent hydrocarbon group having 1 or more and 12 or less carbon atoms as a substituent.

4. A method for producing the cyclic olefin copolymer according to claim 1, comprising:
subjecting the cyclic olefin monomer and the α-olefin to addition polymerization in the presence of a titanocene catalyst represented by the following formula (1) and a co-catalyst,
wherein the co-catalyst comprises a borate compound and a hindered phenol, and
the addition polymerization is performed at a temperature in a range of 10° C. or higher and 60° C. or lower: 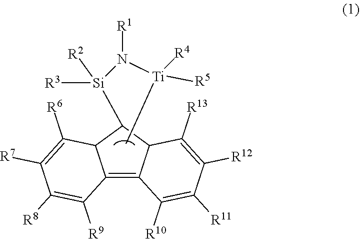
wherein R¹ to R³ are each independently an alkyl group having 1 or more and 6 or less carbon atoms or an aryl group having 6 or more and 12 or less carbon atoms, R⁴ and R⁵ are each independently an alkyl group having 1 or more and 12 or less carbon atoms, an aryl group having 6 or more and 12 or less carbon atoms, or a halogen atom, and R⁶ to R¹³ are each independently a hydrogen atom, an alkyl group having 1 or more and 12 or less carbon atoms, an aryl group having 6 or more and 12 or less carbon atoms, or a silyl group optionally having a monovalent hydrocarbon group having 1 or more and 12 or less carbon atoms as a substituent.
